(19) United States
(12) Patent Application Publication
(10) Pub. No.: US 2015/0326642 A1
(43) Pub. Date: Nov. 12, 2015

(54) CONTENT-BASED DESKTOP SHARING

(71) Applicants: Junwei Cao, (US); Guoyu Tu, (US); EMPIRE TECHNOLOGY DEVELOPMENT LLC, Wilmington, DE (US)

(72) Inventors: Junwei Cao, Beijing (CN); Guoyu Tu, Beijing (CN)

(21) Appl. No.: 14/647,603

(22) PCT Filed: Mar. 6, 2013
(86) PCT No.: PCT/CN2013/072228

§ 371 Date: May 27, 2015

(51) Int. Cl. H04L 29/08; G06F 17/30

(52) U.S. Cl. CPC H04L 67/025; G06F 17/30876

(57) ABSTRACT

To share content of a desktop of a local computing device, the local computing device may be configured to extract contents of each visible window of the desktop and may further, compress and encode the contents. The compressed and encoded contents may then be transmitted to a remote computing device for reconstructing windows corresponding to the visible windows on the local computing device.

### TECHNICAL FIELD

The technologies described herein pertain generally to sharing contents of windows that are visible ona local computing device desktop onto a desktop of a remote computing device.

### BACKGROUND

Unless otherwise indicated herein, the approaches described in this section are not prior art to the claims in this application and are not admitted to be prior art by inclusion in this section.

To share contents of a desktop of a local computing device, the local computing device may be configured to transmit multiple screenshots to a remote computing device. Alternatively, the local computing device may extract contents of each visible window of the desktop and transmit the extracted contents to the remote computing device.

### SUMMARY

Technologies are generally described for content-based desktop sharing. The various techniques may be implemented in various devices, methods and/or systems.

In some examples, various techniques may be implemented as methods on computing devices. Some methods may include receiving active content associated with a first window, the first window being an active window corresponding to a first display, receiving arrangement information regarding an arrangement of the active content in the first window, and activating a second window corresponding to a second display using the arrangement information to reflect, in the second window, the active content of the first window.

In some other examples, other methods may include identifying, by a processor, active content of a first window, the first window being an active window corresponding to a first computing device, and rendering, by the processor, the active content in a second window corresponding to a second computing device.

In some examples, various techniques can be implemented as computer-readable mediums on a local computing device. Some computer-readable mediums may store instructions that, when executed, cause one or more processors to perform operations including identifying one or more active windows corresponding to a first computing device, identifying at least a portion of content in the one or more active windows as content for sharing, determining arrangement information regarding an arrangement of the content for sharing in the one or more active windows, and providing the content for sharing and the arrangement information to a second computing device.

In some examples, various techniques can be implemented as systems on a remote computing device. Some systems may include a first component configured to receive content and corresponding arrangement information of one or more active windows corresponding to a first computing device, and a second component configured to provide the content and the arrangement information to a second computing device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items. In the drawings:

FIG. 1 shows an example system in which content-based desktop sharing may be implemented, arranged in accordance with at least some embodiments described herein;

FIG. 2 shows an example window by which content-based desktop sharing may be implemented, arranged in accordance with at least some embodiments described herein;

FIG. 3 shows an example encoded content by which content-based desktop sharing may be implemented, arranged in accordance with at least some embodiments described herein;

FIG. 4 shows an example configuration of a processing flow of operations by which content-based desktop sharing may be implemented, arranged in accordance with at least some embodiments described herein;

FIG. 5 shows a block diagram illustrating an example computing device that is arranged for content-based desktop sharing, arranged in accordance with at least some embodiments described herein.

### DETAILED DESCRIPTION

In the following detailed description, references are made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

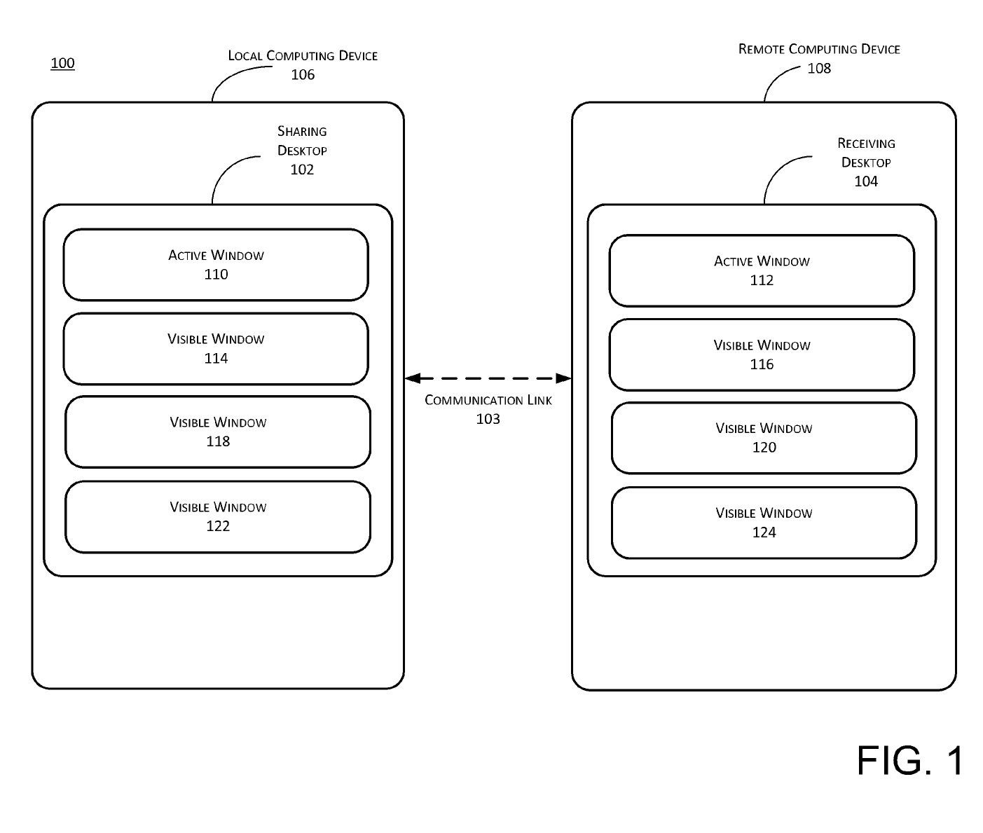

FIG. 1 shows an example system 100 in which content-based desktop sharing may be implemented, arranged in accordance with at least some embodiments described herein. As depicted, example system 100 may include, at least, a local computing device 106 configured to display contents on a sharing desktop 102 and a remote computing device 108 configured to display contents on a receiving desktop 104. Sharing desktop 102 may include an active window 110 and one or more visible windows 114, 118, 122, etc. Similarly, receiving desktop 104 may include an active window 112 and one or more visible windows 116, 120, 124, etc. Receiving desktop 104 may be configured to receive contents from sharing desktop 102 via a communication link 103. Active window 112 and visible windows 116, 120, and 124 may be reconstructed based on the received contents. Of course, sharing desktop 102 is not limited to include just active window 110 and visible windows 114, 118, and 112; and, similarly, receiving desktop 104 is not limited to include just active window 112 and visible windows 116, 120, and 124. The quantity and disposition of such features are depicted and described in the context of embodiments, and are not intended to be limiting in any manner.

As described herein, “desktop” may refer to a graphical user interface that treats the computer monitor as if it is the user's physical desktop, upon which objects such as documents and folders of documents may be stored. A document may be opened into a window, which represents a paper copy of the document stored on the desktop and shows the contents of the document.

As described herein, “window” may refer to a two dimensional object arranged on the aforementioned desktop. A window may display the contents in the form of text, images, videos, line drawings, etc. A window may be resized, moved, hidden, restored or closed and may include other interactive graphical objects, such as toolbars, for a user to modify, change, or edit the contents. Visible windows 114, 118, 122, etc. may refer to windows that are visibly displayed to a user of local computing device 106. Active window 110 may refer to one of the visible windows in which a user may interact with the contents thereof

Local computing device 106 and remote computing device 108, respectively, may be implemented as a personal computer including both laptop computer and non-laptop computers configuration. Further, local computing device 106 and remote computing device 108, respectively, may also be implemented as a portion of a small-form factor portable (or mobile) electronic device such as a cell phone, a person data assistant (PDA), a personal media player device, a wireless web-watch device, a personal headset device, an application specific device, or a hybrid device that include any of the above function. Local computing device 106 and remote computing device 108 may be configured to store, host, or otherwise provide access to digital contents that are displayed on sharing desktop 102 and shared to receiving desktop 104, respectively.

Sharing desktop 102 may be configured to receive and display, at least in active window 110, the digital contents that are stored, hosted, or otherwise accessed by local computing device 106, and to construct one or more visible windows 114, 118, 122, etc. based on the aforementioned digital contents. Further, active window 110 may be visibly distinguished from displayed windows 114, 118, 122, etc., using, e.g., a different colored title bar.

The user may be allowed to switch windows from active window 110 to one of visible windows 114, 118, 112, etc. The previously visible window may then become the current active window and, thus, make the latter a visible window. Different operating systems may provide different ways for the user to switch from one active window to another. For example, if sharing desktop 102 is built on the Microsoft Windows® operating system, the user may move the cursor and click one of the visible windows 114, 118, 122, etc. Alternatively, the user may use some key combinations such as Alt+Tab or Win+Tab.

In accordance with at least some embodiments, local computing device 106 may be configured to store, host, or otherwise provide access to the digital contents that are displayed in each of active window 110 and visible windows 114, 118, 122, etc. In addition, the arrangement information of the contents, which indicates the relative positions of portions of the contents and relationship among the portions of the contents within each window, may also be extracted from active window 110, visible windows 114, 118, 112, etc. The extracted contents and arrangement information may be encoded or compressed into one or more data packages that may be transmitted, by local computing device 106, to remote computing device 108. Remote computing device 108 may be configured to extract the contents and the arrangement information from the data packages. Active window 112 and visible window 116, 120, 124, etc., may be reconstructed based on the arrangement information.

Further, each of active window 112 and one or more of visible windows 116, 120, 124, etc., may be reconstructed corresponding to each of active window 110 and visible windows 114, 118, 122, etc. For example, reconstructed active window 112 may be configured to display the same contents that are currently displayed in active window 110. The displayed contents in active window 112 may be arranged in accordance with the arrangement information so that the contents displayed in active window 110 may also be displayed in active window 112 in a relatively similar position same as displayed in active window 110. The specific format of active window 112, however, may be in a format that is native to remote computing device 108 and, therefore, different from the format of active window 110.

For example, if active window 110 is built upon a Microsoft® Windows® operating system and active window 112 is built on an open-source, e.g., Linux® operating system, active window 112 may be reconstructed as an open-source active window 112. That is, the reconstructed active window 112 may appear to be in the native format of open source operating system. Further, because active window 112 is reconstructed following the arrangement information, the contents of active windows 112 may be reconstructed in the same relative positions as in active window 110 built on the Microsoft® Windows® operating system.

In accordance with at least some embodiments, information regarding the operating system on local computing device 106 may be transmitted together with the extracted contents and arrangement information. The information, e.g., handle, may include the type of the operating system and/or the software on which the respective windows are built on local computing device 106. Such information may be used in reconstructing active window 112 and one or more of visible windows 116, 120, 124, etc., on remote computing device 108, so that the reconstructed windows may be graphically similar to corresponding ones of active window 110 and visible windows 114, 118, 122, etc.

In accordance with some embodiments, after the reconstruction of active window 112 and visible window 116, 120, 124, etc., on remote computing device 108, the contents of active window 110 on local computing device 106 may be updated periodically and transmitted to remote computing device 108 since the contents of visible windows may typically change when one of the visible windows becomes an active window.

Thus, FIG. 1 shows an example system 100 in which one or more embodiments of content-based desktop sharing may be implemented.

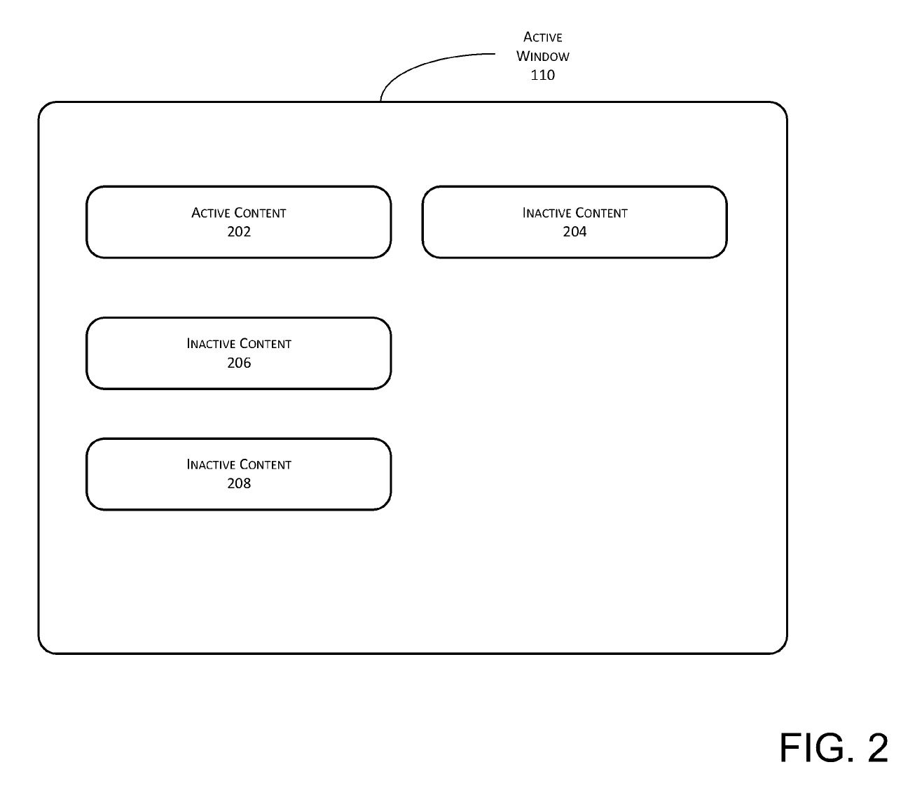

FIG. 2 shows an example active window 110 by which content-based desktop sharing may be implemented, arranged in accordance with at least some embodiments described herein. As depicted, the displayed contents of active window 110 may include active content 202, and inactive content 204, 206, 208, etc. Each of contents, 202, 204, 206, 208, etc., may refer to any type of displayable contents including text, images, video streams, and etc. As displayed in active window 110, active content 202, and inactive content 204, 206, 208, etc., may be arranged in a predetermined order, sequence, or organizational pattern that indicates relative positions of portions of the contents and relationship among the portions of the content, e.g., ones of content 202, 204, 206, and/or 208.

In accordance with some embodiments, inactive content 204, 206, and 208 may refer to any type of displayable content, as mentioned above, but is not currently subject to interaction by the user, e.g., advertisement-related content. Active content 202, therefore, may be extracted, compressed or encoded, and transmitted to remote computing device 108 when active content 202 is modified, changed, or edited by the user. Active content 202 may refer to text, images, or other displayable content with which a user of local computing device 106 may interact

In accordance with some embodiments, the predetermined order, sequence, or organization of the contents of active window 110 may be utilized to construct active window 112. The arrangement information including the predetermined order, sequence, or organization of the contents may, therefore, be extracted from active window 110, compressed or encoded by local computing device 106, and transmitted to remote computing device 108 together with the contents. For example, active content 202 may refer to text with which a user of local computing device 106 is currently interacting. Inactive content 204 may refer to a previous comment made by a review to active content 202. Inactive content 206 and 208 may refer to some paragraphs of text that is within a same document of and follows active content 202. The arrangement information may then indicate that inactive content 204 is at the right side of active content 202 and that active content 202, inactive content 206 and 208 are approximately in the same column. In active window 112, reconstructed active content 202, inactive content 204, 206, and 208 may, therefore, be arranged in the approximate order, sequence, and/or organizational structure as in active window 110, based upon the received arrangement information.

Thus, FIG. 2 shows an example active window 110 by which one or more embodiments of content-based desktop sharing may be implemented, arranged in accordance with at least some embodiments described herein.

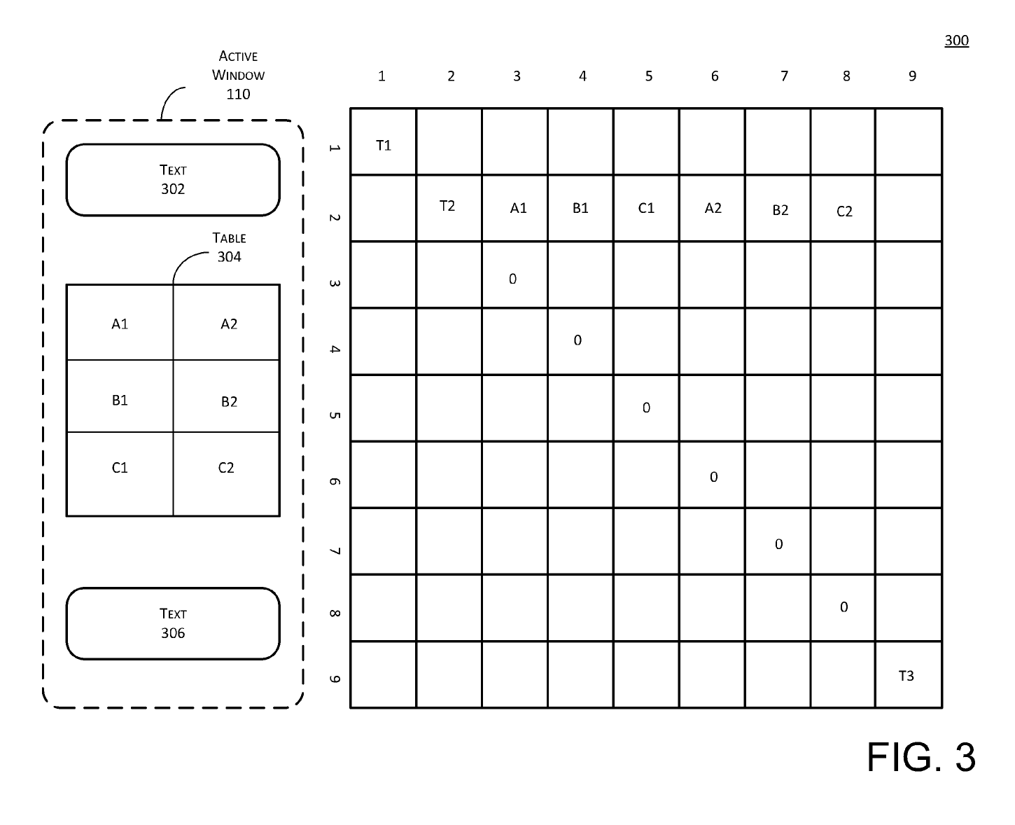

FIG. 3 shows an example encoded content by which one or more embodiments of content-based desktop sharing may be implemented, arranged in accordance with at least some embodiments described herein. As depicted, the contents of active window 110 may include, e.g., text 302, table 304, and text 306. These contents may be encoded into a matrix 300, e.g., 9-by-9, so that the arrangement information including the order, sequence, or organization of the contents may be transmitted to remote computing device 108 for reconstructing in corresponding ones of active window 112 and visible windows 116, 120, 124, etc.

Text 302 may refer to one or more paragraphs of text grouped by local computing device 106. Such grouping may be implemented, at least, partially based on the type of content, e.g., text. That is, continuous text may be grouped together as a block separated from other blocks that include tables, images, or videos. Thus, each block may include one type of content that is grouped together.

Table 304 may refer to a table, e.g., 3-by-2, following text 302. Table 304 may be regarded as a separate block that is distinguishable from text 302 and 306. Element A1, B1, and C1may refer to the three elements in the first column respectively. Element A2, B2, and C2 may refer to the three elements in the second column respectively.

Similar to text 302, text 306 may refer to one or more paragraphs of text grouped by local computing device 106.

Matrix 300, which may serve as an abstract data structure by which arrangement information regarding active window 110 and visible windows 114, 118, 122, etc., may be transmitted from local computing device 106 to remote computing device 108, may be composed of data from, e.g., the content displayed in active window 110. The starting position of text 302 in matrix 300 may be stored in entry (1,1) as T1. With respect to table 304, the starting position of table 304 may be stored in entry (2, 2) as T2. The three elements in the first column, A1, B1, and C1, may be stored respectively in entry (2, 3), (2, 4), and (2, 5). The three elements in the second column, A2, B2, and C2 may be stored in entry (2, 6), (2, 7), and (2, 8). The starting position of text 306 may be stored in entry (9, 9) as T3. Filled matrix 300 may then include the encoded arrangement information, which contains the order, sequence, or organization of the contents, for remote computing device 108 to reconstruct the contents in active window 112. The aforementioned encoding is an example only and is not intended to be limiting in any manner.

Thus, FIG. 3 shows an example encoded content by which one or more embodiments of content-based desktop sharing may be implemented.

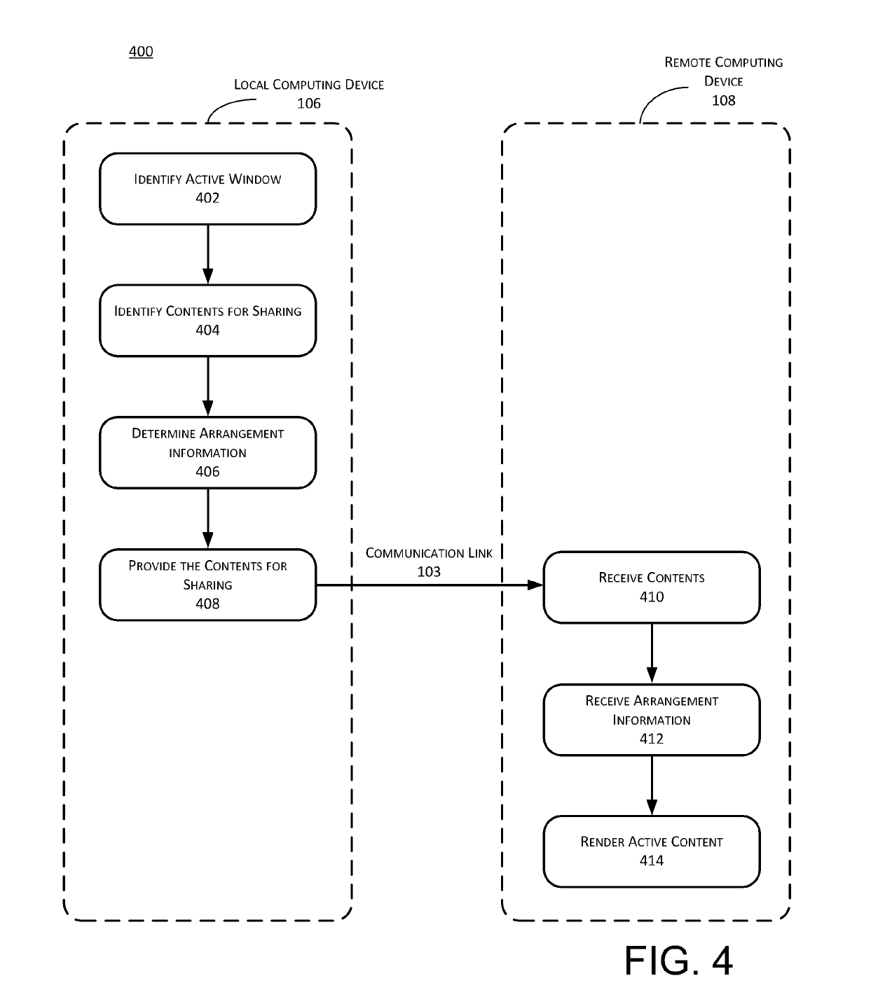

FIG. 4 shows an example configuration 400 of a processing flow of operations by which one or more embodiments of content-based desktop sharing may be implemented, arranged in accordance with at least some embodiments described herein. As depicted, processing flow 400 may include sub-processes executed by various components that are part of example device 100. However, processing flow 400 is not limited to such components, and modification may be made by re-ordering two or more of the sub-processes described here, eliminating at least one of the sub-processes, adding further sub-processes, substituting components, or even having various components assuming sub-processing roles accorded to other components in the following description. Processing flow 400 may include various operation, functions, or actions as illustrated by one or more of blocks 402, 404, 406, 408, 410, 412, and/or 414. Processing may begin at block 402.

Block 402 (Identify Active Window) may refer to local computing device 106 identifying active window 110 among one or more visible windows, e.g., visible windows 116, 120, 124, etc., displayed on a desktop, e.g., sharing desktop 102. The one or more active windows may refer to one or more of the visible windows, with which the user may interact. Active window 110 may each be distinguishable over visible windows 114, 118, 122, etc., when it includes a differently colored title bar. A user may be allowed to switch from active window 110 to one of visible windows 114, 118, 122, etc., and, thus, make the latter an active window. Processing may continue from block 402 to 404.

Block 404 (Identify Contents for Sharing) may refer to local computing device 106 identifying at least a portion of the contents of active window 110 as contents for sharing. The contents of each of visible windows 114, 118, 122, etc., may include active contents and inactive contents (i.e., non-active contents), both of which may be extracted, compressed or encoded, and transmitted to remote computing device 108 for reconstruction. When no modifications are made to the inactive contents of the visible windows, local computing device 106 may extract, compress or encode, and transmit the active contents. In some examples, when the contents of active window 110 are modified, changed, or edited, local computing device 106 may be configured to identify a change of the contents. Processing may continue from block 404 to 406.

Block 406 (Determine Arrangement Information) may refer to local computing device 106 determining arrangement information of the contents of one of active window 110 and visible windows 114, 118, 122, etc. The arrangement information may indicate a predetermined order, sequence, or organizational structure that further indicates the relative positions of portions of the contents of the respective visible windows, as well as any position relationship among the portions of the contents. In some examples, when the arrangement information is modified, changed, or edited, local computing device 106 may be configured to determine a change of the arrangement information. Processing may continue from block 406 to 408.

Block 408 (Provide the Contents for Sharing) may refer to local computing device 106 providing, to remote computing device 108 via communication link 103, the contents for sharing and the arrangement information of the contents for sharing. The contents for sharing may be grouped into one or more blocks based on the type of the portions of the contents. For example, text may be grouped together as a block, while digital images may be grouped in another block. In accordance with some embodiments, the arrangement information that indicates the predetermined order, sequence, or organization of the contents of active window 110 may be crucial in reconstructing active window 112. The arrangement information may, therefore, be extracted from active window 110 and visible windows 114, 118, 122, etc, compressed or encoded, and transmitted by local computing device 106 to remote computing device 108 together with the identified contents for sharing. In some further examples, when the identified contents for sharing and/or the arrangement information are changed, modified or edited by a user, the change of the identified contents and/or the arrangement information may be provided by local computing device 106 to remote computing device 108. Processing may continue from block 408 to 410.

Block 410 (Receive Contents) may refer to remote computing device 108 receiving contents of visible windows 114, 118, 122, etc., displayed on sharing desktop 102. The received contents may include contents of one or more active windows. Processing may continue from block 410 to 412.

Block 412 (Receive Arrangement Information) may refer to remote computing device 108 receiving the arrangement information of the contents for sharing determined and provided by local computing device 106. The arrangement information may indicate a predetermined order, sequence, or organization that further indicates the relative positions of portions of the received contents and relationship among the portions of the received contents. Processing may continue from block 412 to 414.

Block 414 (Render Active Content) may refer to remote computing device 108 activating one or more visible windows, each of which may be corresponding to each visible window displayed on sharing desktop 102, on receiving desktop 104 and further rendering the received contents based on the received arrangement information. In some examples, when the identified contents for sharing and/or the arrangement information are changed, modified, or edited by a user, remote computing device 108 may be configured to update the rendered contents of the activated windows according to the modified arrangement information.

In accordance with some other examples, local computing device 106 and remote computing device 108 may be executing a same operating system. The handle of each visible window may then transmitted by local computing device 106 and received by remote computing device 108. Remote computing device may then reconstruct active window 112, visible window 116, 120, and 124 with a high graphical similarity.

Thus, FIG. 4 shows an example configuration 400 of a processing flow of operations by which one or more embodiments of content-based desktop sharing may be implemented.

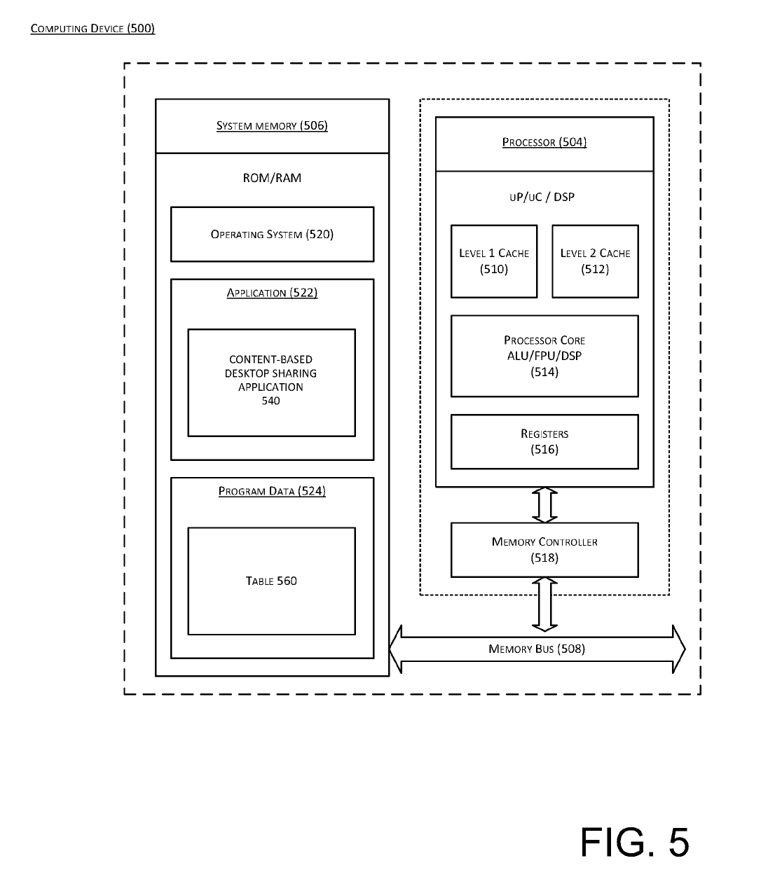

FIG. 5 shows a block diagram illustrating an example computing device that is arranged for content-based desktop sharing, arranged in accordance with at least some embodiments described herein.

More particularly, FIG. 5 shows an illustrative computing embodiment, in which any of the processes and sub-processes described herein may be implemented as computer-readable instructions stored on a computer-readable medium. The computer-readable instructions may, for example, be executed by a processor of a device, as referenced herein, having a network element and/or any other device corresponding thereto, particularly as applicable to the applications and/or programs described above corresponding to the example wireless communication system.

In a very basic configuration, a computing device 500 may typically include one or more processors 504 and a system memory 506. A memory bus 508 may be used for communicating between processor 504 and system memory 506.

Depending on the desired configuration, processor 504 may be of any type including but not limited to a microprocessor (μP), a microcontroller (μC), a digital signal processor (DSP), or any combination thereof. The processor 504 may include one or more levels of caching, such as a level one cache 510 and a level two cache 512, a processor core 514, and registers 516. An example processor core 514 may include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, system memory 506 may be of any type including but not limited to volatile memory (such as RAM), non-volatile memory (such as ROM, flash memory, etc.) or any combination thereof. System memory 506 may include an operating system 520, one or more applications 522, and program data 524.

Application 522 may include a content-based desktop sharing application 540 to implement the content-based desktop sharing schemes as described previously with respect to FIGS. 1-4. Program data 524 may include a table 560, which may be useful for content-based desktop sharing as described herein.

System memory 506 is an example of computer storage media. Computer storage media may include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein may be implemented, e.g., hardware, software, and/or firmware, and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes for wireless communication system 100 via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, e.g., as one or more programs running on one or more computer systems, as one or more programs running on one or more processors, e.g., as one or more programs running on one or more microprocessors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors, e.g., feedback for sensing position and/or velocity; control motors for moving and/or adjusting components and/or quantities. A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Lastly, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “ a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “ a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method, comprising:
receiving content associated with a first window that is an active window corresponding to a first display;
receiving arrangement information regarding an arrangement of the active content in the first window; and
activating a second window corresponding to a second display using the arrangement information to reflect, in the second window, the active content of the first window.

2. The method of claim 1, wherein the active window is identified from one or more windows that are visibly displayed on the first display.

3. The method of claim 1, wherein the first display is associated with a first computing device and the second display is associated with a second computing device.

4. The method of claim 1, wherein the receiving arrangement information includes receiving the arrangement information in at least one of an encoded format or a compressed format.

5. The method of claim 1, where the receiving content of a first window includes:
determining that the first window is visibly displayed on the first display; and
receiving a handle of the first window.

6. The method of claim 1,
wherein content of the first window includes active content and inactive content, and
wherein the inactive content includes an advertisement-related content.

7. The method of claim 1, wherein the arrangement information includes information regarding relative positions of a plurality of portions of the content and information regarding relationships among the plurality of portions of the active content.

8. The method of claim 1, wherein the activating a second window includes constructing the second window in a native format.

9. The method of claim 1, further comprising:
receiving an indication of a change in the active content of the first window; and
updating content of the second window according to the indicated change.

10. The method of claim 1, further comprising:
receiving an indication of a change in the arrangement information; and
updating at least an organization or a manner of displaying content of the second window according to the indicated change.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A system, comprising:
a first component configured to receive content and corresponding arrangement information of an active window corresponding to a first computing device; and
a second component configured to provide the content and the arrangement information to a second computing device.

32. The system of claim 31, wherein the first component is configured to receive the content and the arrangement information by performing operations comprising:
identifying the active window;
identifying at least a portion of the content in the active window as content for sharing; and
determining the arrangement information regarding an arrangement of the content for sharing in the active window.

33. The system of claim 31, wherein the active window comprise one or more windows visibly displayed by the first computing device.

34. The system of claim 31, wherein the arrangement information includes information regarding relative positions of a plurality of portions of the content for sharing and information regarding relationships among the plurality of portions of the content for sharing.

35. The system of claim 31, further comprising:
a third component configured to encode the arrangement information,
wherein the second component is configured to provide the encoded arrangement information to the second computing device.

36. The system of claim 31, further comprising:
a fourth component configured to compress the content for sharing and the arrangement information,
wherein the second component is configured to provide a compressed version of the content for sharing and the arrangement information to the second computing device.

37. The system of claim 31, wherein the second component is further configured to provide information regarding an operating system operating on the first computing device to the second computing device.

38. The system of claim 31, further comprising:
a fifth component configured to receive information indicating a change in the content for sharing,
wherein the second component is further configured to provide the information indicating the change to the second computing device.

39. The system of claim 31, further comprising:
a fifth component configured to receive information indicating a change in the arrangement information,
wherein the second component is further configured to provide the information indicating the change to the second computing device.

40. The system of claim 31, further comprising:
a sixth component configured to activate one or more second windows corresponding to the second computing device to reflect the content for sharing in a native format of the second computing device.

41. The system of claim 40, further comprising:
a database configured to store reconstruction information that supports construction of the content for sharing in the one or more second windows according to the arrangement information,
wherein the sixth component is configured to activate the one or more second windows using the reconstruction information stored in the database.
